(19) United States
(12) Patent Application Publication
(10) Pub. No.: US 2004/0103749 A1
(43) Pub. Date: Jun. 3, 2004

(54) Reduced pressure indexing table

(76) Inventor: David Wayne Schaefer, Champlin, MN (US)

Correspondence Address: Thomas Raffin, 2542 Brookfield Lane, Mendota Heights, MN, 55120, US

(21) Appl. No.: 10/719,946

(22) Filed: Nov. 19, 2003

Related U.S. Application Data
(60) Provisional application No. 60/428,148, filed on Nov. 22, 2002.

(51) Int. Cl. B23Q 16/00

(52) U.S. Cl. 74/813 R

(57) ABSTRACT

A new and improved reduced pressure index table for supporting a workpiece on a machine tool includes a base with a workpiece supporting table on one end of a support screw shaft for rotation to index the workpiece for machine tool operations and a closely coupled locking plate on the other end of the support screw shaft with a key lock for making accurate steps in precision increments. A pneumatically operated drive system is provided for rotating the table in two directions about a longitudinal axis of the support screw and an indexing wheel is provided adjacent to the screw shaft having a plurality of index slots spaced angularly around the periphery for securing the table in a selected fixed positions. Two secured pins on the locking plate are provided for engaging preset holes to lock the screw shaft and the workpiece supporting table in a fixed position and when the locking plate is retracted, the table is then permitted to rotate toward a next indexing position.

### BACKGROUND OF THE INVENTION

1. Field of the Invention

The present invention relates to indexing tables and more particularly to a workpiece supporting table for sequentially positioning a workpiece carried thereon into desired indexing positions ready for successive machine tool operations to be performed on the workpiece. Moreover, this indexing table requires a minimum of force to carry out the operations, resulting in a safer table for operations during successive machine tool or other operations carried out thereon.

2. Description of the Prior Art

### Existing Indexing Tables

Indexing tables have been around for several years, and manufacturers have made many different types of indexing tables for various precision levels. A pneumatically operated rotating table has been manufactured by the Vogel Machine Corporation of Turin Italy, and the Jackson Company of the United States has produced rotary turrets and indexing tables. The following U.S. patents have been directed towards indexing tables: U.S. Pat. No. 4,721,017 Jorgensen et al.; U.S. Pat. No. 2,288,023 Ortegren et al.; U.S. Pat. No. 2,618,982 Mead; U.S. Pat. No. 2,871,732 Olson; U.S. Pat. No. 2,874,599 charlat; U.S. Pat. No. 3,267,772 Burg; U.S. Pat. No. 3,267,772 gardner; U.S. Pat. No. 4,380,939 and U.S. Pat. No. 4,550,631 Yamazaki, et al.

### BACKGROUND OF THE INVENTION

### OBJECTS OF THE PRESENT INVENTION

It is an object of the present invention to provide a new and improved precision rotary table for use with standard machines for drilling, tapping, chucking and boring.

Another object of the invention is to provide a new and improved method of movement of the indexing table delivering a high degree of precision, yet operating with a minimum of force for a safer workplace environment.

Another object of the present invention is to provide a new and improved indexing table of the character described which is substantially lower in cost than existing tables yet provides bi-directional movements with no backlash.

Yet another object of the present invention is to provide a new and improved indexing table of the character described which is capable of extremely fast and repeatable positions.

Still another object of the present invention is to provide a new and improved precision indexing table of the character described which is extremely accurate in positioning a workpiece bi-directionally and which is capable of providing repeat accuracy of 0.03 degrees (+/−0.002@8.00 inch diameter).

### BRIEF SUMMARY OF THE INVENTION

The forgoing and other objects and advantages of the present invention are accomplished in a new and improved reduced pressure indexing table having a base with a workpiece supporting table on one end of a support screw shaft for rotation to index the workpiece for machine tool operations and a closely coupled locking plate on the other end of the support screw shaft with a key lock for making accurate steps in precision increments. A pneumatically operated drive system is provided for rotating the table in two directions about a longitudinal axis of the support screw and an indexing wheel is provided adjacent to the screw shaft having a plurality of index slots spaced angularly around the periphery for securing the table in a selected fixed positions. Two secured pins on the locking plate are provided for engaging preset holes to lock the screw shaft and the workpiece supporting table in a fixed position and when the locking plate is retracted, the table is then permitted to rotate toward a next indexing position.

### BRIEF DESCRIPTION OF THE DRAWINGS

For a better understanding of the present invention, reference should be had to the following detailed description taken in conjuncture with the drawings, in which:

FIG. 1 is the exploded view of a new and improved reduced pressure indexing table constructed in accordance with the features of the present invention;

FIG. 2 is a vertical cross-sectional view taken along the lines of . . . of FIG. 1;

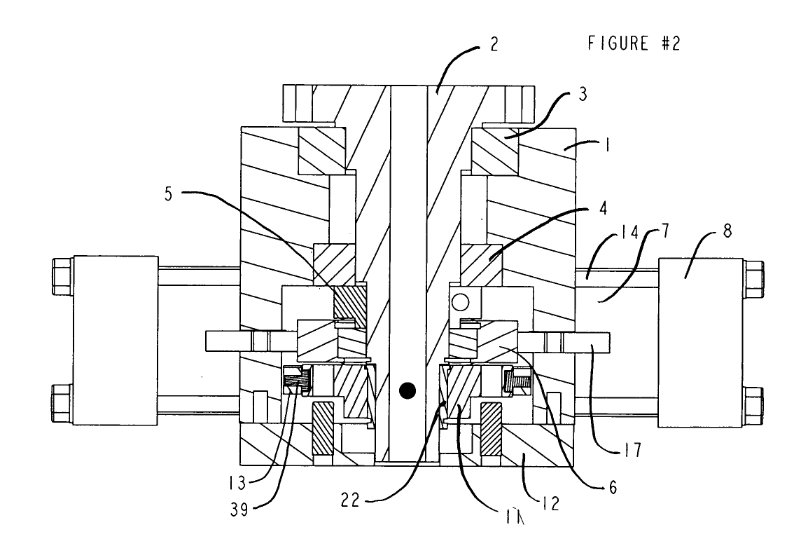

FIG. 3 is a horizontal cross-sectional view taken along the lines . . . of FIG. 1;

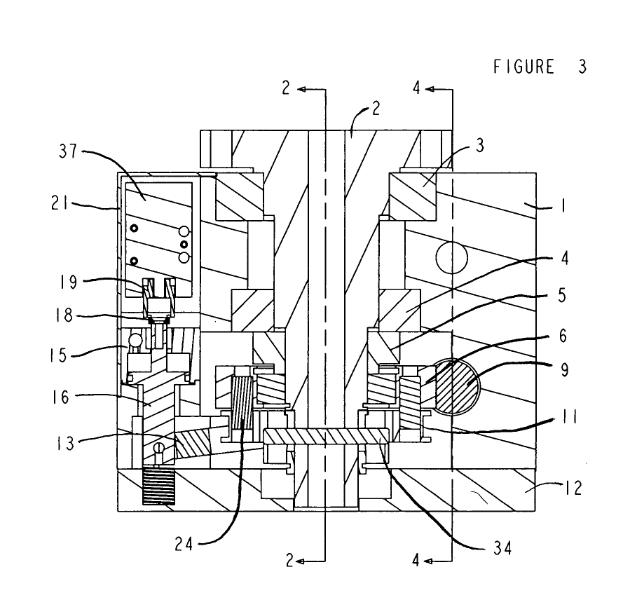

FIG. 4 is a cross sectional view of FIG. 1; and

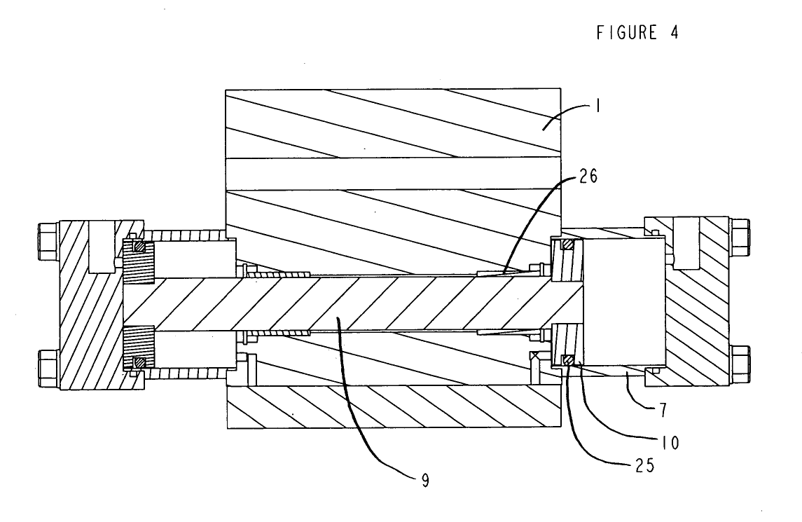

FIG. 5 is a pneumatic diagram of the portion of the control system for controlling the reduced pressure indexing table of the present invention.

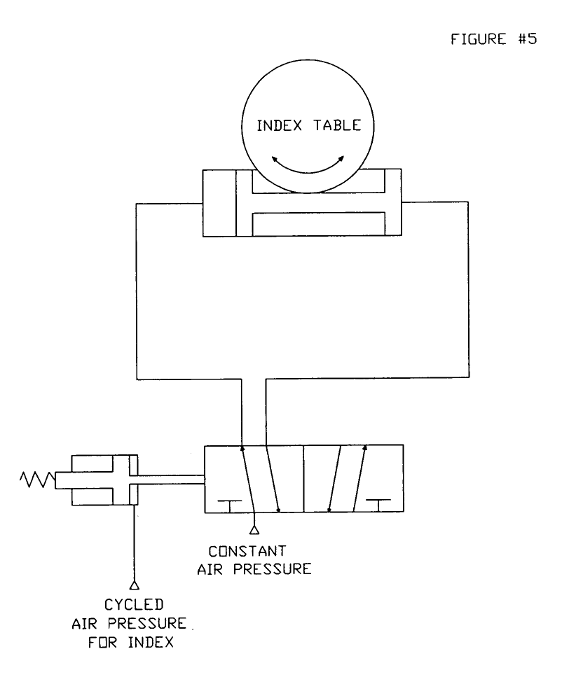

### BRIEF DESCRIPTION OF A PREFERRED EMBODIMENT OF THE INVENTION

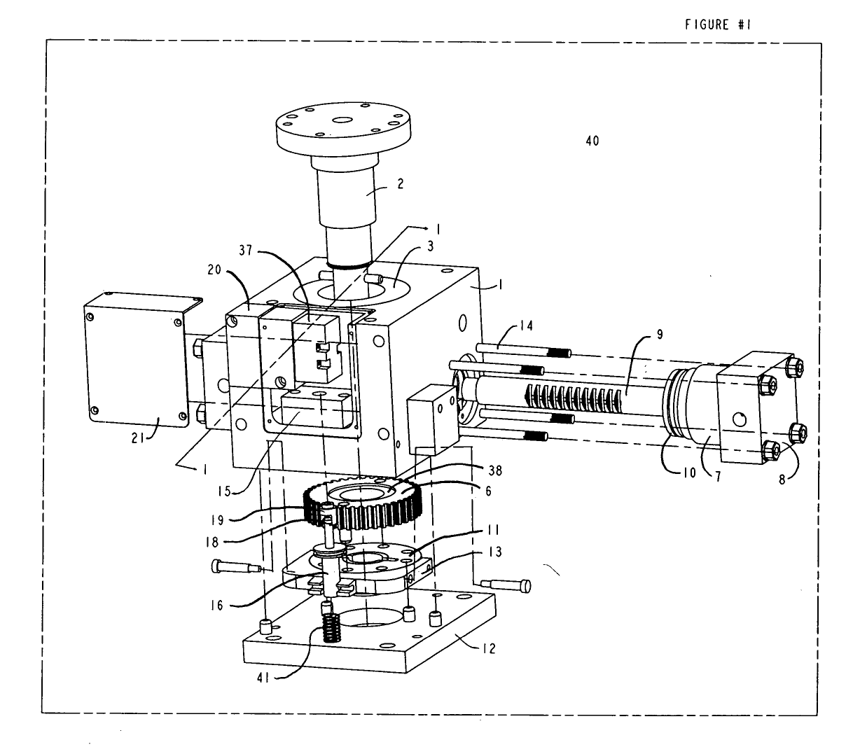

Referring now more particularly to the drawings, therein is illustrated a new and improved reduced pressure indexing table for supporting a workpiece for bidirectionally supporting a workpiece for rotary indexing movement for drilling, tapping, chucking and assembly operations in a standard machine tool such as a drilling and tapping machine, etc. The indexing table of the present invention is referred to generally by the reference #40 and is adapted for supporting a workpiece on spindle #2 in position for precision rotary indexing so that operations of drilling, tapping, chucking, assembly, etc., can be performed on a standard machine tool on which the indexing table is installed. The indexing table is comprised of a housing #1 roughly square in shape having a spindle #2 on one end of said body connected to a cylinder drive shaft #9 running through said housing with a driving gear #6 attached to said cylinder drive shaft with an index plate attached to said cylinder drive shaft. This plate is removeably mounted on a bottom plate by two dowel pins #34. The bottom plate #12 is manufactured to be removeably mounted on a bed or way of a machine tool as shown in FIG. 1 the index plate is circular in shape with a multitude of holes equally spaced located around a central hole through which the spindle passes. Above said index plate #11 is a radially toothed drive gear #6 which is tightly affixed to said spindle #2 and having a drive shaft #9 mounted orthogonally to said drive gear. There is an index plate so that when the radial teeth of drive gear #6 are engaged by teeth of a reciprocally moveable valve #37, the spindle will be rotated in a clockwise or counterclockwise direction as the valve #37 moves on an advancing stroke. Said index plate shall first move upwards via a pivot plate #13 surrounding said index plate #11 to move said index plate away from said bottom plate #12 and at the end of the advancing stroke, said piston activates a pneumatic valve # contained in said body transferring air to another air piston #9 which is connected to said driving gear #6 to turn said index plate allowing said spindle and driving gear to turn. When air pressure is applied to cylinder block #15, this forces index cylinder rod into pivot plate #13, causing the index plate #11 to engage driving gear #6. At the end of the stroke of cylinder #15, valve 37 changes direction causing drive shaft #9 to advance which rotates gear #6. At the end of rotation of driving gear #6, which arm #17 activates valve #36 changing air flow out of cylinder #15. This removes air pressure on index cylinder rod #16, causing spring #41 to force pivot plate #13 up which in turn pushes index plate #11 down disengaging drive shaft #6. At the end of the stroke of cylinder #115, air flow is redirected to the opposite end of cylinder drive shaft #9, causing this cylinder to retract back to its original position ready for another cycle.

Since this indexing table is bilaterally symmetrical, changing the side air flow is applied to will result in the spindle changing from clockwise rotation to counterclockwise rotation. The amount of air pressure applied to the drive shaft is directly proportional to the amount of torque turning spindle #2. Therefore, this can result in substantially less torque than an electric motor-driven index table.

I claim:

1. An indexing table comprising:
a stationary base or key plate having two fixedly attached pins for securing said table in a rotational position corresponding to a selected slot;
a body containing a screw column, a spur gear having a plurality of index slots at angularly spaced apart intervals fixedly attached to said screw column, a pivot plate with a moveably attached pivot plate cylinder, two pneumatic valves in associated cylinders and a drive gear rotationally attached to said spur gear;
a drive means for rotating said table about a central longitudinal axis of said screw column.
